(19) United States
(12) Patent Application Publication
(10) Pub. No.: US 2024/0278155 A1
(43) Pub. Date: Aug. 22, 2024

(54) FLUID DEVICE

(71) Applicant: SEIKO EPSON CORPORATION, TOKYO (JP)

(72) Inventors: Chikara KOJIMA, Matsumoto-shi (JP); Yoshio ARAI, Shiojiri-shi (JP); Keita KUBO, Matsumoto-shi (JP); Hiroto TOMIOKA, SHIOJIRI-SHI (JP)

(21) Appl. No.: 18/443,341

(22) Filed: Feb. 16, 2024

(30) Foreign Application Priority Data
Feb. 17, 2023 (JP) 2023-023227

(51) Int. Cl. B01D 43/00; B06B 1/02

(52) U.S. Cl. CPC B01D 43/00; B06B 1/023; B06B 2201/55; B06B 2201/70

(57) ABSTRACT

A fluid device includes a chamber that is provided with an inlet and an outlet opened at different positions on an X axis and is formed with a flow path space in which a fluid is caused to flow from the inlet to the outlet, a first ultrasonic element configured to generate a standing wave in a direction along an X axis in the fluid in the chamber, a driver configured to drive the first ultrasonic element, and a drive controller configured to control the driver such that a drive voltage applied to the first ultrasonic element is reduced over time.

The present application is based on, and claims priority from JP Application Serial Number 2023-023227, filed Feb. 17, 2023, the disclosure of which is hereby incorporated by reference herein in its entirety.

### BACKGROUND

### 1. Technical Field

The present disclosure relates to a fluid device.

### 2. Related Art

A fluid device is known in the related art; the fluid device captures fine particles dispersed in a fluid and separates the fluid into a concentrated fluid having a high concentration of fine particles and a diluted fluid having a low concentration of fine particles. For example, a fluid device disclosed in WO2005/058459 includes a flow path through which a liquid flows, and an ultrasonic wave generation unit that forms a standing wave in a width direction of the flow path. Since particles in a fluid flow through the flow path in a flow direction and converge to a part of a region in a width direction of the flow path corresponding to a position of a node of the standing wave, a concentrated fluid having a high concentration of fine particles is recovered through a concentration path opened to the region.

WO2005/058459 is an example of the related art.

However, in the fluid device disclosed in WO2005/058459 in the related art, when particles of many sizes are mixed in the fluid, the particles cannot be classified. When a plurality of fluid devices are coupled to one another and are configured such that an acoustic radiation force of a standing wave is increased toward a downstream fluid device, fine particles can be classified, but there is a problem that a size of the entire device is increased.

### SUMMARY

A fluid device according to a first aspect of the present disclosure includes a chamber that is provided with an inlet and an outlet opened at different positions on a first axis and that is formed with a flow path space through which a fluid is caused to flow from the inlet to the outlet, a first ultrasonic element configured to generate a first standing wave in a direction along the first axis in the fluid in the chamber, a driver configured to drive the first ultrasonic element, and a drive controller configured to control the driver such that a drive voltage applied to the first ultrasonic element is reduced over time.

A fluid device according to a second aspect of the present disclosure includes a chamber that is provided with an inlet and an outlet opened at different positions on a first axis and is formed with a flow path space in which a fluid is caused to flow from the inlet to the outlet, a first ultrasonic element configured to generate a first standing wave in a direction along the first axis in the fluid in the chamber, a fluid supplier configured to supply the fluid to the inlet, and a supply controller configured to control the fluid supplier such that a flow velocity of the fluid supplied to the inlet is increased over time.

### BRIEF DESCRIPTION OF THE DRAWINGS

FIG. 1 is a block diagram showing an overall configuration of a fluid device according to a first embodiment.

FIG. 2 is a schematic diagram showing a configuration of a separation module according to the first embodiment.

FIG. 3 is a schematic diagram showing a configuration of the separation module according to the first embodiment.

FIG. 4 is a simulation diagram related to a flow of a fluid flowing through a chamber according to the first embodiment.

FIG. 5 is a flowchart showing a control method of the fluid device according to the first embodiment.

FIG. 6 is a schematic diagram showing a control method of the fluid device according to the first embodiment.

FIG. 7 is a block diagram showing an overall configuration of a fluid device according to a second embodiment.

FIG. 8 is a flowchart showing a control method of the fluid device according to the second embodiment.

### DESCRIPTION OF EMBODIMENTS

### First Embodiment

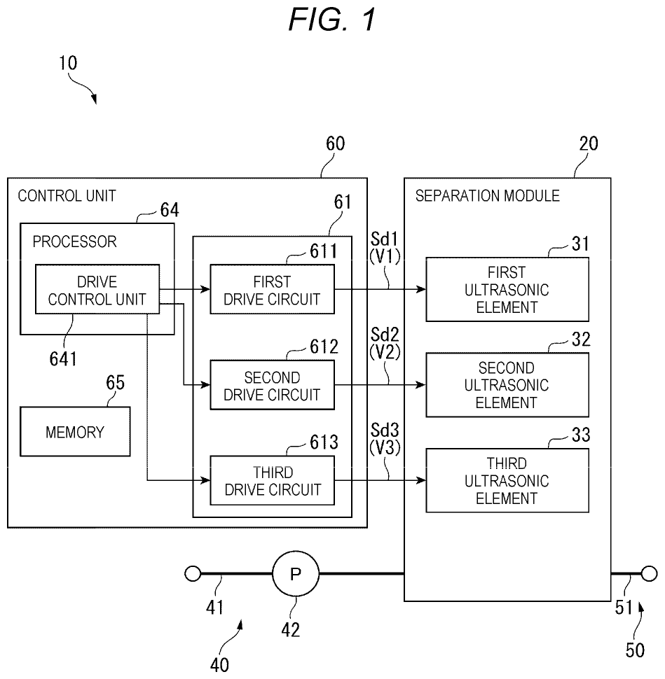

A fluid device 10 according to a first embodiment will be described with reference to FIGS. 1 to 6.

### Configuration of Fluid Device 10

FIG. 1 is a block diagram showing an overall configuration of the fluid device 10. As shown in FIG. 1, the fluid device 10 according to the embodiment includes a separation module 20, a fluid supplier 40 that supplies a fluid to the separation module 20, a fluid recovery unit 50 that recovers the fluid from the separation module 20, and a control unit 60 that controls an operation of the separation module 20.

The fluid device 10 according to the embodiment captures fine particles in a fluid flowing through the separation module 20 by an acoustic radiation force of ultrasonic waves. Since the acoustic radiation force of ultrasonic waves is reduced over time, a fluid in which fine particles are concentrated can be recovered and fine particles can be classified and recovered. In the embodiment, the fluid is not particularly limited, and may be any liquid such as water or blood. The fine particles are not particularly limited, and for example, the fine particles include fine fibers and cells.

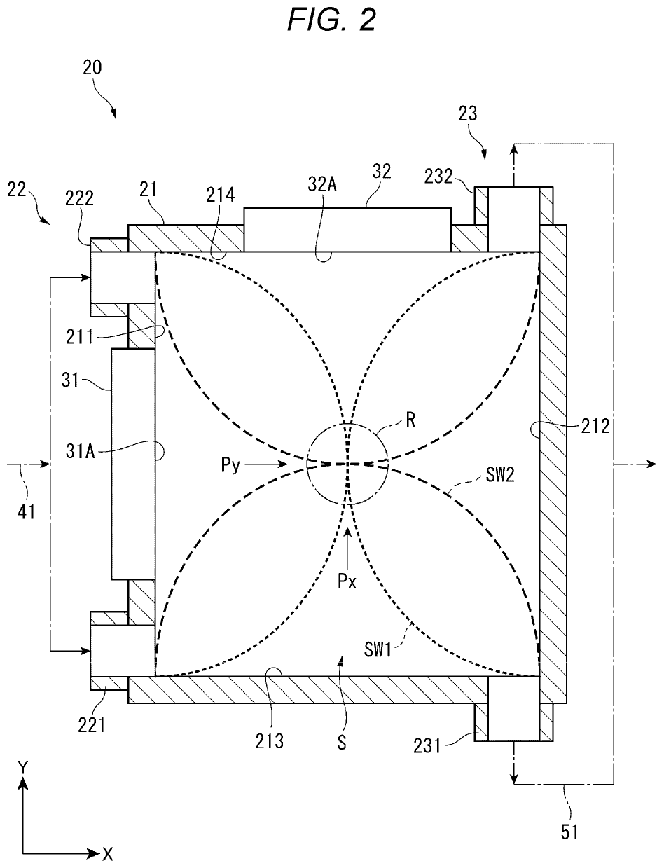

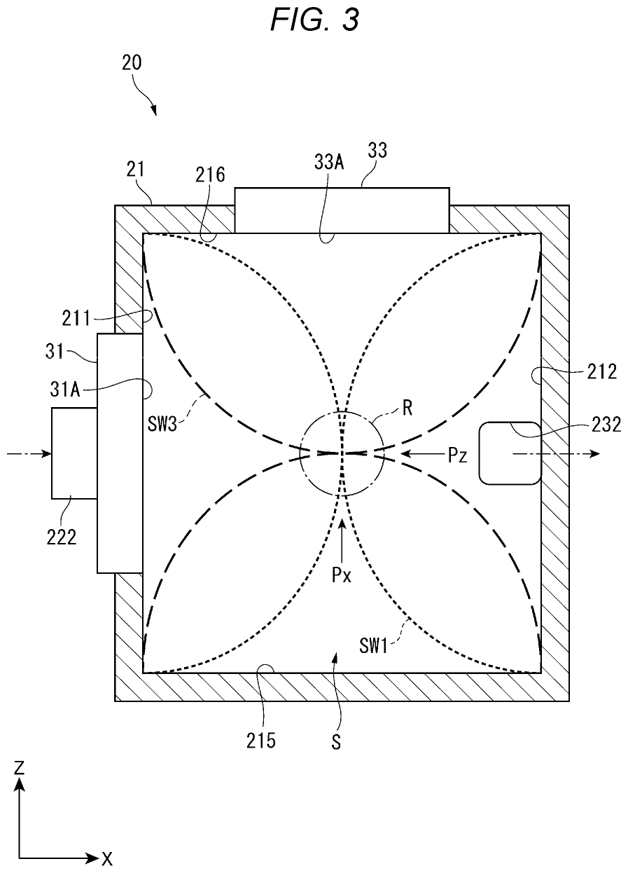

FIGS. 2 and 3 are schematic diagrams showing a configuration of the separation module 20. FIG. 2 shows a cross section of the separation module 20 cut along an X axis and a Y axis, and FIG. 3 shows a cross section of the separation module 20 cut along the X axis and a Z axis. The X axis (a first axis) and the Y axis (a second axis) are axes orthogonal to each other, and an axis orthogonal to the X axis and the Y axis is defined as the Z axis (a third axis).

As shown in FIGS. 2 and 3, the separation module 20 includes a chamber 21 that is filled with a fluid and in which the fluid flows, and a first ultrasonic element 31, a second ultrasonic element 32, and a third ultrasonic element 33 that are provided in the chamber 21.

The chamber 21 according to the embodiment forms a rectangular flow path space S, and includes wall surfaces 211 and 212 facing each other in an X direction, wall surfaces 213 and 214 facing each other in a Y direction, and wall surfaces 215 and 216 facing each other in a Z direction.

The chamber 21 is provided with an inlet 22 and an outlet 23 that are opened at different positions on the X axis.

The inlet 22 according to the embodiment includes a first inlet 221 and a second inlet 222 that are opened on the wall surface 211. The first inlet 221 and the second inlet 222 are opened at both end portions of the wall surface 211 in the Y direction, and are coupled to a supply flow path 41 of the fluid supplier 40 which will be described later.

The outlet 23 according to the embodiment includes a first outlet 231 that is opened on the wall surface 213 and a second outlet 232 that is opened on the wall surface 214. The first outlet 231 and the second outlet 232 are coupled to a recovery flow path of the fluid recovery unit 50 which will be described later.

The first ultrasonic element 31 has an ultrasonic wave transmission surface 31A constituting a part of the wall surface 211. The first ultrasonic element 31 faces the flow path space S in the chamber 21 via the ultrasonic wave transmission surface 31A.

A drive signal Sd1 (see FIG. 1) having a predetermined frequency set in accordance with a distance between the wall surfaces 211 and 212 in the X direction (a transmission distance of ultrasonic waves) is input to the first ultrasonic element 31. When the drive signal Sd1 is input, the first ultrasonic element 31 transmits ultrasonic waves having a predetermined frequency from the ultrasonic wave transmission surface 31A. Here, the ultrasonic waves transmitted from the ultrasonic wave transmission surface 31A are diffused into the fluid in the chamber 21 in a radiation manner, and the ultrasonic waves traveling along the X axis are repeatedly reflected between the wall surfaces 211 and 212 to form a standing wave SW1 (corresponding to a first standing wave according to the present disclosure) in a direction along the X axis.

The second ultrasonic element 32 has an ultrasonic wave transmission surface 32A constituting a part of the wall surface 214. The second ultrasonic element 32 faces the flow path space S in the chamber 21 via the ultrasonic wave transmission surface 32A.

A drive signal Sd2 (see FIG. 1) having a predetermined frequency set in accordance with a distance between the wall surfaces 213 and 214 in the Y direction (a transmission distance of ultrasonic waves) is input to the second ultrasonic element 32. When the drive signal Sd2 is input, the second ultrasonic element 32 transmits ultrasonic waves having a predetermined frequency from the ultrasonic wave transmission surface 32A. Here, the ultrasonic waves transmitted from the ultrasonic wave transmission surface 32A are diffused into the fluid in the chamber 21 in a radiation manner, and the ultrasonic waves traveling along the Y axis are repeatedly reflected between the wall surfaces 213 and 214 to form a standing wave SW2 (corresponding to a second standing wave according to the present disclosure) in a direction along the Y axis.

The third ultrasonic element 33 has an ultrasonic wave transmission surface 33A constituting a part of the wall surface 216. The third ultrasonic element 33 faces the flow path space S in the chamber 21 via the ultrasonic wave transmission surface 33A.

A drive signal Sd3 (see FIG. 1) having a predetermined frequency set in accordance with a distance between the wall surfaces 215 and 216 in the Z direction (a transmission distance of ultrasonic waves) is input to the third ultrasonic element 33. When the drive signal Sd3 is input, the third ultrasonic element 33 transmits ultrasonic waves having a predetermined frequency from the ultrasonic wave transmission surface 33A. Here, the ultrasonic waves transmitted from the ultrasonic wave transmission surface 33A are diffused into the fluid in the chamber 21 in a radiation manner, and the ultrasonic waves traveling along the Z axis are repeatedly reflected between the wall surfaces 215 and 216 to form a standing wave SW3 (corresponding to a third standing wave according to the present disclosure) in a direction along the Z axis.

In the embodiment, when a frequency of the ultrasonic waves transmitted from each of the first ultrasonic element 31, the second ultrasonic element 32, and the third ultrasonic element 33 is defined as f, a mode order of a standing wave is defined as m, a sound velocity in a fluid is defined as c, and a transmission distance of the ultrasonic waves transmitted from each of the ultrasonic elements is defined as L, a standing wave is formed when a condition of the following Equation (1) is satisfied.

$$Equation 1$$

$$f = \frac{m c}{2 L} \qquad ( 1 )$$

Specific configurations of ultrasonic elements constituting the first ultrasonic element 31, the second ultrasonic element 32, and the third ultrasonic element 33 are not particularly limited. For example, an ultrasonic element may be configured to vibrate a piezoelectric actuator, or may be configured to vibrate a vibration plate on which a piezoelectric element is formed. Such an ultrasonic element generates a vibration when a drive signal (a drive voltage) having a predetermined frequency is applied, and the ultrasonic element transmits ultrasonic waves.

For example, in an ultrasonic element having a vibration plate on which a piezoelectric element is formed, when a drive signal is input to the piezoelectric element, the vibration plate is vibrated in a flexural manner in a thickness direction due to expansion and contraction of the piezoelectric element. When the flexural vibration of the vibration plate is converted into compressional waves of a fluid, ultrasonic waves are transmitted from the ultrasonic element to the fluid.

Hereinafter, the first ultrasonic element 31, the second ultrasonic element 32, and the third ultrasonic element 33 may be collectively referred to as ultrasonic elements 31 to 33.

As shown in FIG. 1, the fluid supplier 40 includes the supply flow path 41 through which a liquid flows from any fluid supply source to the separation module 20, and a pump 42 provided in the supply flow path 41. The pump 42 may be any device that generates a flow of a fluid, such as a peristaltic pump and a diaphragm pump. The supply flow path 41 according to the embodiment branches on a downstream side, and has two downstream ends respectively coupled to the first inlet 221 and the second inlet 222 (see FIG. 2).

The fluid recovery unit 50 includes a discharge flow path 51 through which a fluid discharged from the separation module 20 flows. The discharge flow path 51 according to the embodiment branches on an upstream side, and has two upstream ends respectively coupled to the first outlet 231 and the second outlet 232 (see FIG. 2). Although not shown in FIG. 1, the fluid recovery unit 50 may include a plurality of recovery containers coupled to downstream ends of the discharge flow path 51 via a flow path switching unit, or may include a recovery container coupled to the downstream end of the discharge flow path 51 in a replaceable manner.

The control unit 60 includes a driver 61, a processor 64, and a memory 65.

The driver 61 includes a first drive circuit 611 that outputs the drive signal Sd1 having the predetermined frequency to the first ultrasonic element 31, a second drive circuit 612 that outputs the drive signal Sd2 having the predetermined frequency to the second ultrasonic element 32, and a third drive circuit 613 that outputs the drive signal Sd3 having the predetermined frequency to the third ultrasonic element 33. The driver 61 can change amplitudes of the drive signals Sd1 to Sd3 (that is, drive voltages V1 to V3 applied to the ultrasonic elements 31 to 33) under the control of the processor 64.

The processor 64 functions as a drive controller 641 by executing a program stored in the memory 65.

The drive controller 641 controls frequencies of the drive signals Sd1 to Sd3 and the drive voltages V1 to V3 output from the driver 61.

The memory 65 is a storage device that stores various programs and various kinds of data. For example, the memory 65 stores setting information related to the frequencies of the drive signals Sd1 to Sd3 and the drive voltages V1 to V3.

The drive voltages V1 to V3 correspond to amplitudes of the standing waves SW1 to SW3 generated by the ultrasonic elements 31 to 33. An increase or a reduction in the amplitudes of the standing waves SW1 to SW3 increases or reduces an acoustic radiation force acting on fine particles. That is, the control unit 60 can adjust the amplitudes of the standing waves SW1 to SW3 by adjusting the drive voltages V1 to V3, and as a result, the control unit 60 can adjust an acoustic radiation force acting on fine particles.

### Mechanism of Fluid Device 10

A mechanism in which the fluid device 10 according to the embodiment captures fine particles in a fluid will be described. The fine particles in the embodiment have higher acoustic impedance than the fluid. A case where the first ultrasonic element 31, the second ultrasonic element 32, and the third ultrasonic element 33 respectively generate the standing waves SW1 to SW3 of a primary mode is exemplified in the embodiment to simplify the description.

In the fluid device 10 according to the embodiment, the standing waves SW1 to SW3 of a primary mode are formed in the chamber 21 as shown in FIGS. 2 and 3. When a fluid flows through the chamber 21, fine particles in the fluid receive acoustic radiation forces of the respective standing waves SW1 to SW3, and are focused on nodes of sound pressure distributions of the respective standing waves SW1 to SW3.

In the embodiment, nodes (node positions Px on the X axis) of the standing wave SW1 are formed at a central portion of the chamber 21 in the X direction. Nodes (node positions Py on the Y axis) of the standing wave SW2 are formed at a central portion of the chamber 21 in the Y direction, that is, at positions different from the inlet 22 and the outlet 23 on the Y axis. Nodes (node positions Pz on the Z axis) of the standing wave SW3 are formed at a central portion of the chamber 21 in the Z direction, that is, at positions overlapping with the inlet 22 and the outlet 23 on the Z axis.

Here, a region in the vicinity of a point where the nodes of the standing wave SW1 (the node positions Px on the X axis), the nodes of the standing wave SW2 (the node positions Py on the Y axis), and the nodes of the standing wave SW3 (the node positions Pz on the Z axis) overlap with one another is referred to as a capture region R where particles are concentrated. In the embodiment, the capture region R is formed in a central portion of an XYZ space in the chamber 21 as shown in FIGS. 2 and 3.

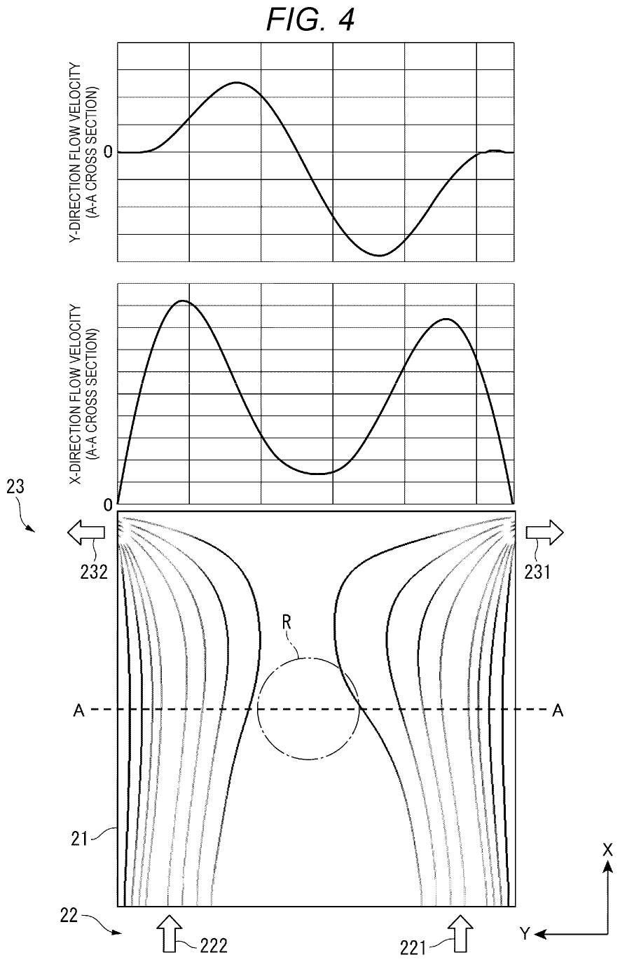

FIG. 4 shows a result of simulation calculating a flow of a fluid flowing through the chamber 21 according to the embodiment. A streamline diagram showing a fluid flowing through the chamber 21 is shown on a lower side of FIG. 4, and a graph showing an X-direction flow velocity in an A-A cross section of the streamline diagram is shown in the center of FIG. 4. A graph showing a Y-direction flow velocity in the A-A cross section of the streamline diagram is shown on an upper side of FIG. 4.

As shown in the streamline diagram of FIG. 4, the first inlet 221 and the second inlet 222 constituting the inlet 22 are provided on both sides of the Y axis relative to the capture region R in the chamber 21 in the embodiment. Similarly, the first outlet 231 and the second outlet 232 constituting the outlet 23 are provided on both sides of the Y axis relative to the capture region R in the chamber 21.

Accordingly, a fluid flowing in from the first inlet 221 flows mainly along the X axis while slightly spreading along the Y axis, and flows out from the first outlet 231. Similarly, a fluid flowing in from the second inlet 222 flows mainly along the X axis while slightly spreading along the Y axis, and is discharged from the second outlet 232. Accordingly, streamlines are sparse in the capture region R in the chamber 21.

Specifically, as shown in the graph in the center of FIG. 4, the X-direction flow velocity in the capture region R in the chamber 21 is smaller than that in regions on both sides of the capture region R. As shown in the graph on the upper side of FIG. 4, the Y-axis flow velocity in the capture region R in the chamber 21 is around 0. Accordingly, in the capture region R in the chamber 21, a flow velocity of a fluid flowing toward the first outlet 231 and the second outlet 232 is reduced. Therefore, fine particles concentrated in the capture region R in the chamber 21 tend to remain in the capture region R.

### Control Method of Fluid Device 10

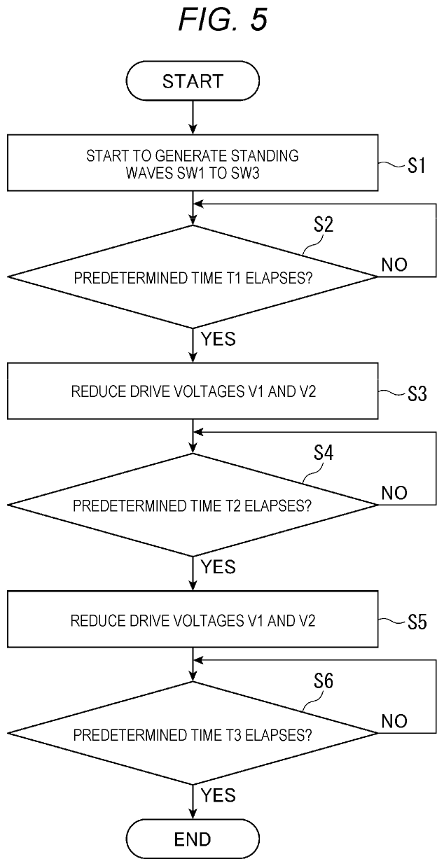

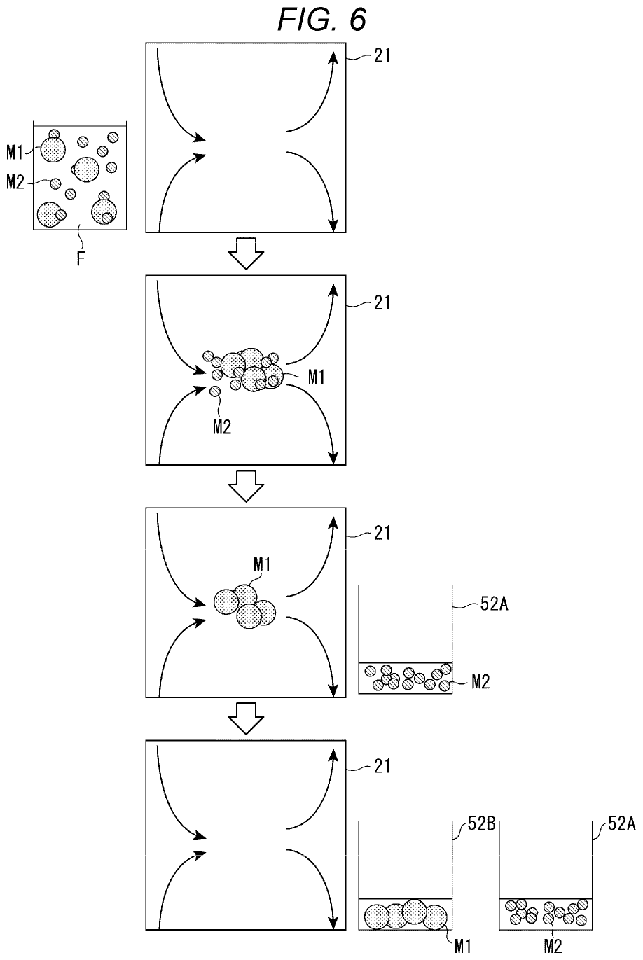

An example of a control method of the fluid device 10 according to the embodiment will be described with reference to a flowchart shown FIG. 5 and a schematic diagram shown in FIG. 6.

Hereinafter, a method of classifying fine particles based on a size will be described. Here, as shown in a first stage of FIG. 6, a fluid F supplied to the fluid device 10 contains two types of fine particles M1 and M2 having different sizes. The fine particles M1 are larger than the fine particles M2. Here, although the spherical fine particles M1 and M2 are exemplified and diameters of the fine particles M1 are larger than diameters of the fine particles M2 for the sake of explanation, shapes of the fine particles M1 and M2 are not limited to a spherical shape.

The fluid supplier 40 continuously supplies the fluid F to the chamber 21 at a constant flow velocity.

First, the drive controller 641 reads setting information of the drive signals Sd1 to Sd3 recorded in the memory 65 and outputs a drive command to the driver 61. Accordingly, the driver 61 starts to output the drive signals Sd1 to Sd3, and the ultrasonic elements 31 to 33 start to generate the standing waves SW1 to SW3 (step S1).

In step S1, the drive voltage V1 is set to a predetermined first voltage value. The first voltage value is a value set to such an extent that an acoustic radiation force of the standing wave SW1 can capture the fine particles M1 and M2, and is determined in advance by an experiment or a simulation. Similar to the drive voltage V1, the drive voltages V2 and V3 are preferably set to the first voltage value.

According to step S1 described above, the fine particles M1 and M2 start to be focused in the capture region R in the chamber 21. When a predetermined time T1 elapses after step S1, the fine particles M1 and M2 are concentrated at a predetermined concentration or more in the capture region R in the chamber 21 as shown in a second stage of FIG. 6.

The predetermined time T1 is a time that is freely set in advance based on desired concentrations of the fine particles M1 and M2.

The drive controller 641 determines whether the predetermined time T1 elapses from an execution time of step S1 (step S2). When it is determined that the predetermined time T1 elapses, the drive voltage V1 is reduced from the first voltage value to a second voltage value (step S3). In step S3 according to the embodiment, the drive controller 641 reduces the drive voltage V2 from the first voltage value to the second voltage value in a similar manner to the drive voltage V1, while keeping the drive voltage V3 constant.

According to step S3, the amplitudes of the standing waves SW1 and SW2 are reduced, and the acoustic radiation forces of the standing waves SW1 and SW2 acting on the fine particles M1 and M2 are reduced. Here, the second voltage value is a value set to such an extent that the acoustic radiation forces of the standing waves SW1 and SW2 capture the fine particles M1 and do not capture the fine particles M2, and is determined in advance by an experiment or a simulation. As a result, the fine particles M1 are continuously captured in the capture region R of the chamber 21, but the fine particles M2 escape from the capture region R and spread on an XY plane, and are discharged from the chamber 21 by being carried by a flow of the fluid F in the chamber 21. When a predetermined time T2 elapses after step S3, most of the fine particles M2 are discharged from the chamber 21 as shown in a third stage of FIG. 6. Accordingly, the fluid F containing the fine particles M2 having a high concentration can be recovered in a container 52A or the like.

The predetermined time T2 is a time required for discharging the fine particles M2 from the chamber 21, and is a time set in advance by an experiment or a simulation.

The drive controller 641 determines whether the predetermined time T2 elapses from an execution time of step S3 (step S4). When it is determined that the predetermined time T2 elapses, the drive voltage V1 is reduced from the second voltage value to a third voltage value (step S5). In step S5 according to the embodiment, the drive controller 641 reduces the drive voltage V2 from the second voltage value to the third voltage value in a similar manner to the drive voltage V1, while keeping the drive voltage V3 constant.

According to step S5 described above, the amplitudes of the standing waves SW1 and SW2 are further reduced, and the acoustic radiation forces of the standing waves SW1 and SW2 acting on the fine particles M1 are further reduced. Here, the third voltage value is a value set to such an extent that the acoustic radiation forces of the standing waves SW1 and SW2 do not capture the fine particles M1, and is determined in advance by an experiment or a simulation. The third voltage value may be set to zero. Accordingly, the fine particles M1 escape from the capture region R and spread on the XY plane, and are discharged from the chamber 21 by being carried by a flow of the fluid F in the chamber 21. When a predetermined time T3 elapses after step S5, most of the fine particles M1 are discharged from the chamber 21 as shown in a fourth stage of FIG. 6. Accordingly, the fluid F containing the fine particles M1 having a high concentration can be recovered in a container 52B or the like.

Before the start of step S5, the fluid F flowing into the chamber 21 is preferably adjusted such that the fluid F does not contain at least the fine particles M2. The predetermined time T3 is a time required for discharging the fine particles M1 from the chamber 21, and is a time set in advance by an experiment or a simulation.

Thereafter, the drive controller 641 determines whether the predetermined time T3 elapses from an execution time of step S5 (step S6). When it is determined that the predetermined time T3 elapses, the flowchart shown in FIG. 5 ends. Accordingly, the supply of the fluid F to the chamber 21 may be stopped.

### Effects of Embodiment

The fluid device 10 according to the embodiment includes the chamber 21 that is provided with the inlet 22 and the outlet 23 opened at different positions on the X axis and that is formed with the flow path space S through which a fluid can flow from the inlet 22 to the outlet 23, the first ultrasonic element 31 configured to generate the standing wave SW1 in a direction along the X axis in the fluid in the chamber 21, the driver 61 configured to drive the first ultrasonic element 31, and the drive controller 641 configured to control the driver 61 such that the drive voltage V1 applied to the first ultrasonic element 31 is reduced over time.

In such a configuration, when the fluid flows mainly along the X axis from the inlet 22 toward the outlet 23 in the chamber 21, fine particles in the fluid are captured at the nodes (the node positions Px on the X axis) of the standing wave SW1 and remain in the chamber 21. Here, when the drive voltage V1 is reduced over time, an amplitude of the standing wave SW1 is reduced. As a result, the acoustic radiation force of the standing wave SW1 acting on the fine particles is reduced, and a lower limit of a size of the fine particles that can be captured is increased. When particles of many sizes are mixed in the fluid, since the drive voltage V1 is reduced over time, fine particles leak after being captured by the standing wave SW1 in order from a smallest size of the fine particles, and are discharged from the outlet 23. Accordingly, the fine particles can be classified. In particular, when the drive voltage V1 is reduced in a stepwise manner, the fine particles can be classified in a stepwise manner.

The fluid device 10 according to the embodiment can efficiently concentrate fine particles in the fluid as compared with a fluid device in the related art.

Specifically, in the fluid device in the related art, fine particles in a fluid are caused to flow in a flow direction of a flow path and are recovered while converging in the fluid in a part of a region in a width direction of the flow path, and thus it is difficult to increase a concentration of the fine particles in the fluid above a certain level.

On the other hand, in the fluid device 10 according to the embodiment, the fine particles converge in the capture region R that is a part of a region on the X axis, while the fluid mainly flows through the chamber 21 in the X direction. Here, when the acoustic radiation force of the standing wave SW1 is equal to or larger than any constant value, fine particles having a size equal to or larger than a lower limit determined according to the constant value are captured in the capture region R and continue to remain in the chamber 21. Accordingly, a concentration of the fine particles in the chamber 21 can be increased together with a flow time of the fluid. Thereafter, when the acoustic radiation force of the standing wave SW1 is smaller than the above constant value, the fine particles accumulated in the chamber 21 are discharged, and the fluid containing the fine particles having a high concentration can be recovered.

The fluid device 10 according to the embodiment further includes the second ultrasonic element 32 configured to generate the standing wave SW2 in a direction along the Y axis in the fluid in the chamber 21.

According to such a configuration, the capture region R of the fine particles is arranged in a region in the vicinity of a point where the nodes (the node positions Px on the X axis) of the standing wave SW1 and the nodes (the node positions Py on the Y axis) of the standing wave SW2 overlap with one another. Accordingly, the capture region R of the fine particles can be prevented from spreading in the XY plane, and the fine particles can be suitably remained in the chamber 21.

In the embodiment, the second ultrasonic element 32 forms nodes of the standing wave SW2 at positions different from the inlet 22 and the outlet 23 on the Y axis.

According to such a configuration, since the capture region R of the fine particles is arranged outside a formation range of a flow from the inlet 22 toward the outlet 23 on the XY plane, the fine particles in the fluid can be suitably remained in the chamber 21.

In the embodiment, the drive controller 641 controls the driver 61 such that the drive voltages V1 and V2 respectively applied to the first ultrasonic element 31 and the second ultrasonic element 32 are reduced over time.

According to such a configuration, the acoustic radiation force in the direction along the X axis of the standing wave SW1 is reduced, and the acoustic radiation force in the direction along the Y axis of the standing wave SW2 is reduced, so that fine particles released from the capture region R can easily move to the outlet 23. Accordingly, recovery efficiency of the fine particles can be improved.

In the embodiment, the inlet 22 includes the first inlet 221 and the second inlet 222 provided on both sides of an arrangement range of the first ultrasonic element 31 on the Y axis, and the outlet 23 includes the first outlet 231 and the second outlet 232 that are provided on an opposite side to the inlet 22 side relative to an arrangement range of the second ultrasonic element 32 on the X axis and are provided on both sides of the arrangement range of the first ultrasonic element 31 on the Y axis.

According to such a configuration, since a region where streamlines of a fluid are sparse and the capture region in the chamber 21 overlap with each other on the XY plane, fine particles can be suitably remained in the chamber 21.

The fluid device 10 according to the embodiment further includes the third ultrasonic element 33 configured to generate the standing wave SW3 in a direction along the Z axis in the fluid in the chamber 21.

According to such a configuration, the capture region R of the fine particles in an XYZ space is set in a region in the vicinity of a point where the nodes (the node positions Px on the X axis) of the standing wave SW1, the nodes (the node positions Py on the Y axis) of the standing wave SW2, and the nodes (the node positions Pz on the Z axis) of the standing wave SW3 overlap with one another. The capture region R of the fine particles can be prevented from spreading in the XYZ space, and the fine particles can be suitably remained in the chamber 21.

In the embodiment, the third ultrasonic element 33 forms nodes of the standing wave SW3 at positions overlapping with the inlet 22 and the outlet 23 on the Z axis. According to such a configuration, since the fine particles released from the capture region R easily move to the outlet 23, recovery efficiency of the fine particles can be improved.

### Second Embodiment

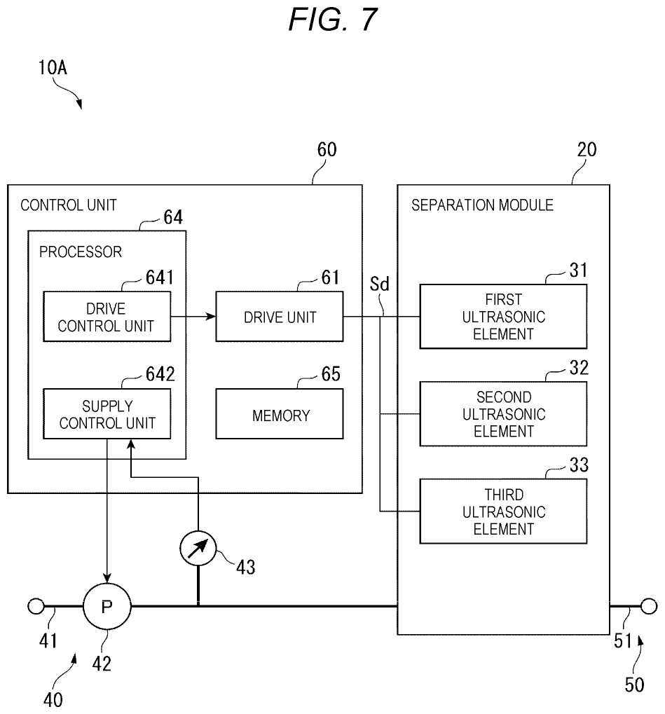

A fluid device 10A according to a second embodiment will be described with reference to FIG. 7.

The fluid device 10A according to the second embodiment has substantially similar configuration to the configuration of the fluid device according to the first embodiment except for providing with a configuration for controlling a flow rate. Hereinafter, configurations the same as those of the first embodiment will be denoted by the same reference numerals, and description of the same configurations will be omitted or simplified.

The processor 64 functions as the drive controller 641 and a supply controller 642 by executing a program stored in the memory 65. The supply controller 642 controls a flow velocity of a fluid supplied to the separation module 20 by controlling a flow rate of the pump 42. The supply controller 642 may perform feedback control of the flow rate of the pump 42 based on a flow rate measured by a flowmeter 43.

The flowmeter 43 may be any device that measures a flow rate of a fluid in the supply flow path 41, such as an ultrasonic flowmeter.

In the second embodiment, the driver 61 may be configured to output the same drive signal Sd to the first ultrasonic element 31, the second ultrasonic element 32, and the third ultrasonic element 33.

### Control Method of Fluid Device 10A

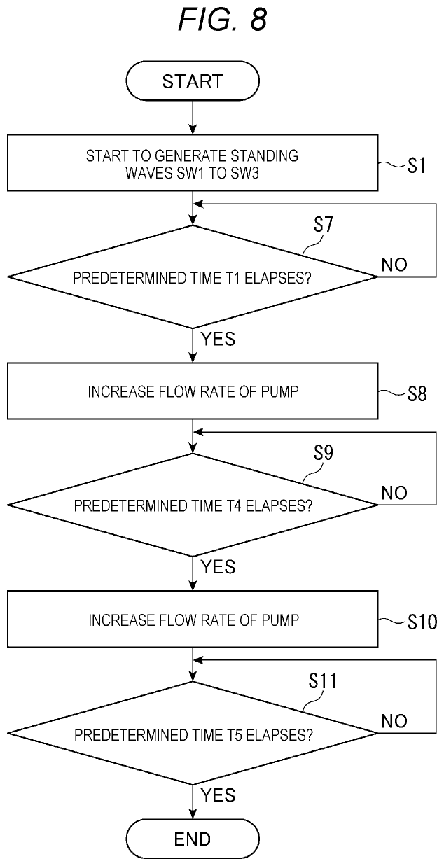

An example of a control method of the fluid device 10A according to the embodiment will be described with reference to a flowchart shown in FIG. 8. Hereinafter, a method of classifying fine particles based on a size will be described in a similar manner to the control method of the fluid device 10 according to the first embodiment. The fluid F supplied to the fluid device 10 contains two types of spherical fine particles M1 and M2 having different sizes. Diameters of the fine particles M1 are larger than diameters of the fine particles M2.

First, the drive controller 641 controls the driver 61, and the driver 61 starts to drive the ultrasonic elements 31 to 33, so that the ultrasonic elements 31 to 33 start to generate the standing waves SW1 to SW3 (step S1), in a similar manner to that in the first embodiment. Accordingly, the fine particles M1 and M2 start to be focused in the capture region R of the chamber 21. When the predetermined time T1 elapses after step S1, the fine particles M1 and M2 are concentrated in the capture region R in the chamber 21.

The supply controller 642 determines whether the predetermined time T1 elapses from the execution time of step S1 (step S7). When it is determined that the predetermined time T1 elapses, the flow rate of the pump 42 is increased (step S8). Accordingly, a flow velocity of a fluid supplied to the separation module 20 is increased.

Here, an acoustic radiation force larger than an acoustic radiation force acting on the fine particles M2 acts on the fine particles M1 that are larger than the fine particles M2. The flow rate of the pump 42 is a value set to such an extent that the fine particles M1 remain in the capture region R against a flow of a fluid, but the fine particles M2 are pushed by a flow of a fluid and leave the capture region R, and the flow rate is determined in advance by an experiment or a simulation.

Accordingly, when a predetermined time T4 elapses after step S8, the fine particles M2 are completely discharged from the chamber 21. Accordingly, the fluid F containing the fine particles M2 having a high concentration can be recovered in a container 52A or the like.

The supply controller 642 determines whether the predetermined time T4 elapses from an execution time of step S8 (step S9). When it is determined that the predetermined time T4 elapses, the flow rate of the pump 42 is further increased (step S10). Accordingly, a flow velocity of a fluid supplied to the separation module 20 is increased.

Here, the flow rate of the pump 42 is a value set to such an extent that the fine particles M1 are pushed by a flow of a fluid and leave the capture region R, and is determined in advance by an experiment or a simulation.

Therefore, when a predetermined time T5 elapses after step S10, the fine particles M1 are completely discharged from the chamber 21. Accordingly, the fluid F containing the fine particles M1 having a high concentration can be recovered in the container 52A or the like.

Before the start of step S10, a fluid flowing into the chamber 21 is preferably adjusted such that the fluid does not contain at least the fine particles M2.

Thereafter, the supply controller 642 determines whether the predetermined time T5 elapses from an execution time of step S10 (step S11). When it is determined that the predetermined time T5 elapses, the flowchart shown in FIG. 8 ends. Accordingly, the supply of a fluid to the chamber 21 may be stopped.

According to the fluid device 10A in the second embodiment described above, fine particles can be classified, and a fluid containing fine particles having a high concentration can be recovered in a similar manner to the first embodiment.

### Modification

The present disclosure is not limited to the embodiments described above. The present disclosure includes modifications, improvements, and configurations obtained by appropriately combining the embodiments within a scope where an object of the present disclosure can be achieved.

Although a case where the first ultrasonic element 31, the second ultrasonic element 32, and the third ultrasonic element 33 respectively generate the standing waves SW1 to SW3 of a primary mode is described in the above embodiments for the sake of simplifying description, a mode order of the standing waves SW1 to SW3 is not particularly limited.

In the above embodiments, the number, a size, and an arrangement of the inlet 22 and the outlet 23 can be freely changed. For example, in the first embodiment, the inlet 22 includes the first inlet 221 and the second inlet 222, and the outlet 23 includes the first outlet 231 and the second outlet 232, so that a region in which streamlines of a fluid are sparse is formed in the chamber 21. The region in which the streamlines of the fluid are sparse can be formed by a combination of the first inlet 221 and the second outlet 232 or a combination of the second inlet 222 and the first outlet 231.

Although the fluid devices 10, 10A according to the above embodiments include the first ultrasonic element 31, the second ultrasonic element 32, and the third ultrasonic element 33, the fluid devices 10, 10A may include at least the first ultrasonic element 31, and the second ultrasonic element 32 and the third ultrasonic element 33 may be omitted.

Although the drive controller 641 reduces the drive voltages V1 and V2 over time in the first embodiment, the drive controller 641 may reduce at least the drive voltage V1 and the drive voltage V2 may be constant. Alternatively, although the drive voltage V3 is constant in the first embodiment, the drive controller 641 may reduce the drive voltage V3 over time in a similar manner to the drive voltages V1 and V2.

Although the drive controller 641 reduces the drive voltages V1 and V2 in a stepwise manner in the first embodiment, the drive controller 641 may reduce the drive voltages V1 and V2 in a continuous manner. Similarly, although the supply controller 642 increases the flow rate of the pump 42 in a stepwise manner in the second embodiment, the supply controller 642 may increase the flow rate in a continuous manner.

The first embodiment and the second embodiment may be combined. For example, when the supply controller 642 increases the flow rate of the pump 42, the drive controller 641 may reduce the drive voltage V1 (and the drive voltage V2) in the second embodiment. Accordingly, a force for capturing fine particles in the capture region R in the chamber 21 can be effectively reduced. The drive controller 641 and the supply controller 642 may have the same control timing or different control timings.

### SUMMARY OF DISCLOSURE

A fluid device according to the present disclosure includes a chamber that is provided with an inlet and an outlet opened at different positions on a first axis and that is formed with a flow path space through which a fluid is caused to flow from the inlet to the outlet, a first ultrasonic element configured to generate a first standing wave in a direction along the first axis in the fluid in the chamber, a driver configured to drive the first ultrasonic element, and a drive controller configured to control the driver such that a drive voltage applied to the first ultrasonic element is reduced over time.

In such a configuration, when the drive voltage is reduced over time, a lower limit of a size of fine particles that can be captured in the chamber is increased. When particles of many sizes are mixed in a fluid, since the drive voltage is reduced over time, fine particles leak after being captured by the standing wave in order from a smallest size of the fine particles, and are discharged from the outlet. Accordingly, the fine particles can be classified.

In the fluid device according to a first aspect of the present disclosure, the drive controller may control the driver such that the drive voltage applied to the first ultrasonic element is reduced in a stepwise manner over time.

According to such a configuration, fine particles can be classified in a stepwise manner.

The fluid device according to the present disclosure may further include a second ultrasonic element configured to generate a second standing wave in a direction along a second axis orthogonal to the first axis in the fluid in the chamber, and the driver may drive the first ultrasonic element and the second ultrasonic element.

According to such a configuration, a capture region of fine particles is arranged in a region in the vicinity of a point where nodes (node positions on the first axis) of the standing wave generated by the first ultrasonic element and nodes (node positions on the second axis) of the standing wave generated by the second ultrasonic element overlap with one another. Accordingly, the capture region of fine particles can be prevented from spreading in a plane defined by the first axis and the second axis, and fine particles can be suitably remained in the chamber 21.

In the fluid device according to the present disclosure, the second ultrasonic element may form nodes of the second standing wave at positions different from the inlet and the outlet on the second axis.

According to such a configuration, since the capture region R of fine particles is arranged in a plane defined by the first axis and the second axis so as to avoid a formation range of a flow from the inlet toward the outlet, fine particles in the fluid can be suitably remained in the chamber.

In the fluid device according to the present disclosure, the drive controller may control the driver such that the drive voltage applied to the first ultrasonic element and a drive voltage applied to the second ultrasonic element are reduced over time.

According to such a configuration, an acoustic radiation force in the direction along the first axis generated by the first ultrasonic element is reduced, and an acoustic radiation force in the direction along the second axis generated by the second ultrasonic element is reduced, so that fine particles released from the capture region can easily move to the outlet. Accordingly, recovery efficiency of the fine particles can be improved.

In the fluid device according to the present disclosure, the inlet may include a first inlet and a second inlet provided on both sides of an arrangement range of the first ultrasonic element on the second axis, and the outlet may include a first outlet and a second outlet that are provided on an opposite side to an inlet side relative to an arrangement range of the second ultrasonic element on the first axis and that are provided on both sides of the arrangement range of the first ultrasonic element on the second axis.

According to such a configuration, since a region in which streamlines of a fluid are sparse and the capture region of fine particles in the chamber overlap with each other in the plane defined by the first axis and the second axis, fine particles can be suitably remained in the chamber.

The fluid device according to the present disclosure may further include a third ultrasonic element configured to generate a third standing wave in a direction along a third axis orthogonal to the first axis and the second axis in the fluid in the chamber, and the driver may drive the first ultrasonic element, the second ultrasonic element, and the third ultrasonic element.

According to such a configuration, a capture region of fine particles is arranged in a region in the vicinity of a point where nodes (node positions on the first axis) of the standing wave generated by the first ultrasonic element, nodes (node positions on the second axis) of the standing wave generated by the second ultrasonic element, and nodes (node positions on the third axis) of the standing wave generated by the third ultrasonic element overlap with one another. The capture region of fine particles can be prevented from spreading in a space defined by the first axis, the second axis, and the third axis, and fine particles can be suitably remained in the chamber.

In the fluid device according to the present disclosure, the third ultrasonic element may form the nodes of the third standing wave at positions overlapping with the inlet and the outlet on the third axis.

According to such a configuration, since fine particles released from the capture region easily move to the outlet, recovery efficiency of the fine particles can be improved.

The fluid device according to the present disclosure may further include a fluid supplier configured to supply a fluid to the inlet, and a supply controller configured to control the fluid supplier such that a flow velocity of the fluid supplied to the inlet is increased over time.

A fluid device according to a second aspect of the present disclosure may include a chamber that is provided with an inlet and an outlet opened at different positions on a first axis and is formed with a flow path space in which a fluid is caused to flow from the inlet to the outlet, a first ultrasonic element configured to generate a first standing wave in a direction along the first axis in the fluid in the chamber, a fluid supplier configured to supply the fluid to the inlet, and a supply controller configured to control the fluid supplier such that a flow velocity of the fluid supplied to the inlet is increased over time.

With such a configuration as well, the same effect as the fluid device according to the first aspect of the present disclosure can be obtained.

What is claimed is:

1. A fluid device comprising:
a chamber that is provided with an inlet and an outlet opened at different positions on a first axis and is formed with a flow path space through which a fluid is caused to flow from the inlet to the outlet;
a first ultrasonic element configured to generate a first standing wave in a direction along the first axis in the fluid in the chamber;
a driver configured to drive the first ultrasonic element; and
a drive controller configured to control the driver such that a drive voltage applied to the first ultrasonic element is reduced over time.

2. The fluid device according to claim 1, wherein
the drive controller controls the driver such that a drive voltage applied to the first ultrasonic element is reduced in a stepwise manner over time.

3. The fluid device according to claim 1, further comprising:
a second ultrasonic element configured to generate a second standing wave in a direction along a second axis orthogonal to the first axis in the fluid in the chamber, wherein
the driver drives the second ultrasonic element.

4. The fluid device according to claim 3, wherein
the second ultrasonic element forms a node of the second standing wave at a position different from the inlet and the outlet on the second axis.

5. The fluid device according to claim 3, wherein
the drive controller controls the driver such that a drive voltage applied to the second ultrasonic element is reduced over time.

6. The fluid device according to claim 3, wherein
the inlet includes a first inlet and a second inlet provided on both sides of an arrangement range of the first ultrasonic element on the second axis, and
the outlet includes a first outlet and a second outlet that are provided on an opposite side of an inlet side relative to an arrangement range of the second ultrasonic element on the first axis and that are provided on both sides of the arrangement range of the first ultrasonic element on the second axis.

7. The fluid device according to claim 3, further comprising:
a third ultrasonic element configured to generate a third standing wave in a direction along a third axis orthogonal to the first axis and the second axis in the fluid in the chamber, wherein
the driver drives the first ultrasonic element, the second ultrasonic element, and the third ultrasonic element.

8. The fluid device according to claim 7, wherein
the third ultrasonic element forms a node of the third standing wave at a position overlapping with the inlet and the outlet on the third axis.

9. The fluid device according to claim 1, further comprising:
a fluid supplier configured to supply the fluid to the inlet; and
a supply controller configured to control the fluid supplier such that a flow velocity of the fluid supplied to the inlet is increased over time.

10. A fluid device comprising:
a chamber that is provided with an inlet and an outlet opened at different positions on a first axis and is formed with a flow path space in which a fluid is caused to flow from the inlet to the outlet;
a first ultrasonic element configured to generate a first standing wave in a direction along the first axis in the fluid in the chamber;
a fluid supplier configured to supply the fluid to the inlet; and
a supply controller configured to control the fluid supplier such that a flow velocity of the fluid supplied to the inlet is increased over time.
